(19) United States
(12) Patent Application Publication
(10) Pub. No.: US 2010/0328079 A1
(43) Pub. Date: Dec. 30, 2010

(54) PROTECTING SYSTEM AND METHOD FOR CAMERA

(75) Inventors: YANG-YUAN CHEN, Tu-Cheng (TW); MING-CHIH HSIEH, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/510,283

(22) Filed: Jul. 28, 2009

(30) Foreign Application Priority Data
Jun. 26, 2009 (CN) 200910303707.9

(51) Int. Cl. G08B 17/00

(52) U.S. Cl. 340/584

(57) ABSTRACT

A protecting system is to protect a camera. When the protecting system detects heat which reaches a predetermined value, the protecting system outputs a first signal. The protecting system further magnifies the first signal to output a second signal. A controlling circuit starts a buzzer when the controlling circuit receives the second signal.

### BACKGROUND

1. Technical Field

The present disclosure relates to protecting systems and methods and, particularly, to a protecting system and a protecting method for a camera.

2. Description of Related Art

Cameras are currently used in video monitoring (or surveillance) systems. Intruders may try to disable or damage the cameras when they enter some places without permission. Nowadays, video monitoring systems warn after intruders have damaged the cameras, and do nothing to prevent the damage from occurring.

### BRIEF DESCRIPTION OF THE DRAWINGS

FIG. 1 is a schematic block diagram of an exemplary embodiment of a protecting system.

FIG. 2 is a schematic diagram of the protecting system of FIG. 1 used for a camera.

FIG. 3 is a flowchart of an exemplary embodiment of a protecting method.

### DETAILED DESCRIPTION

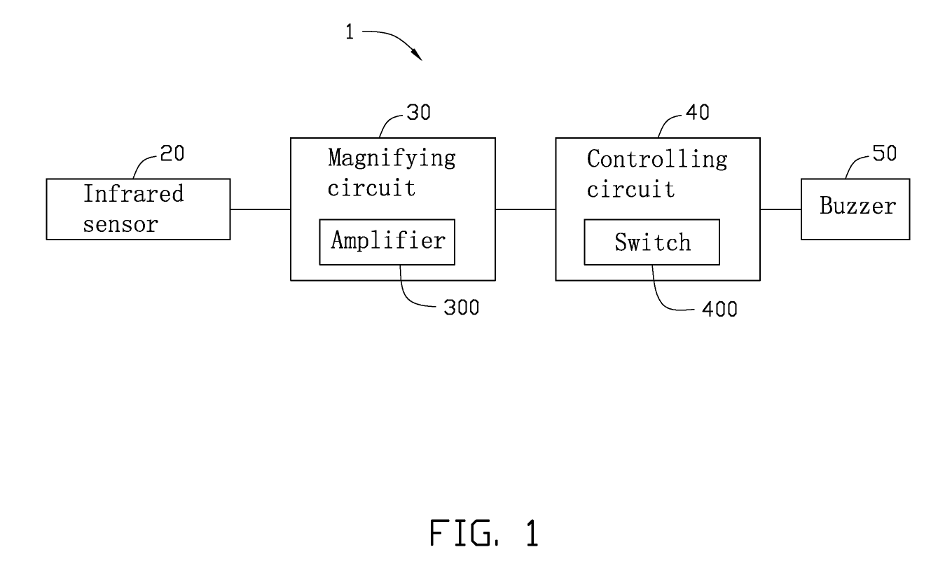

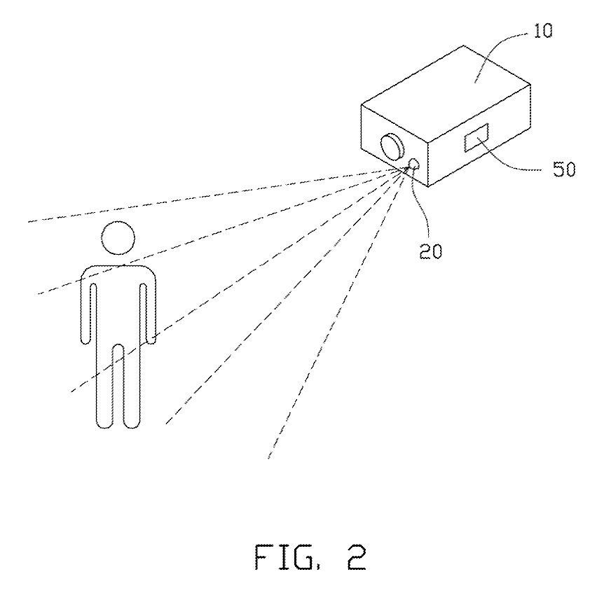

Referring to FIGS. 1 and 2, an exemplary embodiment of a protecting system 1 includes an infrared sensor 20, a magnifying circuit 30, a controlling circuit 40, and an annunciator, such as a buzzer 50. The protecting system 1 is operable to protect a camera 10 in a video monitoring system.

The infrared sensor 20 and the buzzer 50 are mounted on a surface of the camera 10. The magnifying circuit 30 and the controlling circuit 40 are located inside the camera 10.

The infrared sensor 20 senses heat such as that which is emitted from a human intruder. Upon the condition that the infrared sensor 20 detects heat which reaches a predetermined value, the infrared sensor 20 outputs a first signal to the magnifying circuit 30.

The magnifying circuit 30 magnifies the first signal to obtain a second signal. It can be understood that the magnifying circuit 30 is a conventional circuit. In the embodiment, the magnifying circuit 30 may include an amplifier 300.

The controlling circuit 40 receives the second signal to start the buzzer 50. Moreover, the controlling circuit 40 further outputs the second signal to the video monitoring system to warn the system operator that there may be an intruder too close to the camera 10. In the embodiment, the controlling circuit 40 may be a switch 400 connected between the buzzer 50 and a power supply. Upon the condition that the switch 400 receives the second signal, the switch 400 is turned on, and supplies power from the power supply to the buzzer 50. As a result, the buzzer 50 goes off.

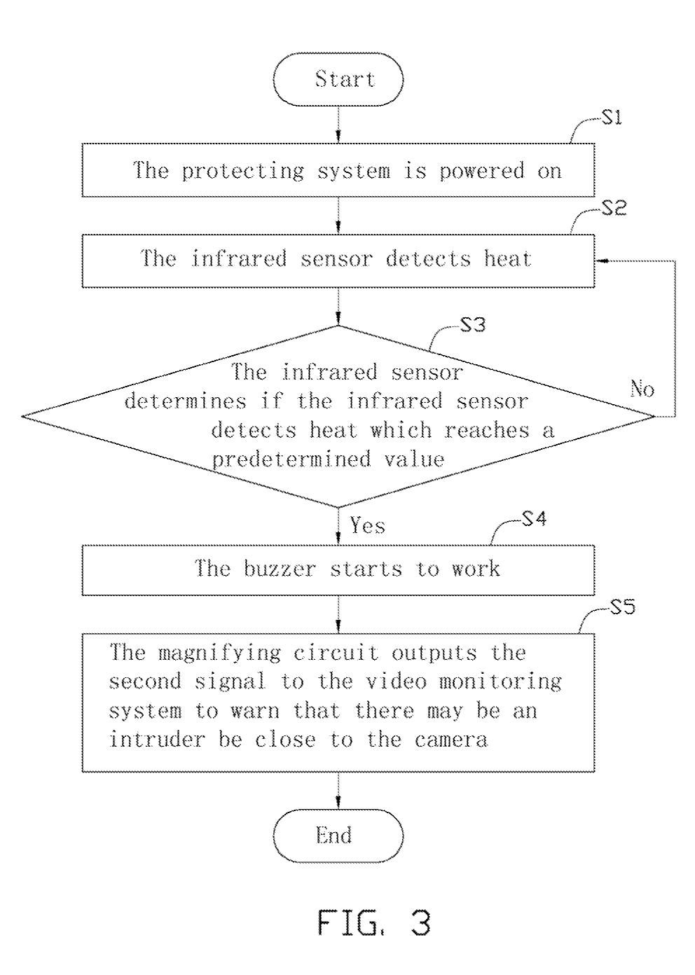

Referring to FIG. 3, an exemplary embodiment of a protecting method using the protecting system 1 in FIG. 1, for protecting the camera 10 in the video monitoring system, includes the following steps.

In step S1, the protecting system 1 is powered on.

In step S2, the infrared sensor 20 detects heat such as that which might be emitted by a human intruder.

In step S3, the infrared sensor 20 determines whether the infrared sensor 20 detects heat. Upon the condition that the infrared sensor 20 detects heat which reaches a predetermined value, the flow goes to step S4. Upon the condition that the infrared sensor 20 does not detect heat which reaches a predetermined value, the flow goes to step S2.

In step S4, the infrared sensor 20 outputs the first signal to the magnifying circuit 30. The magnifying circuit 30 magnifies the first signal to obtain the second signal, and transmits the second signal to the controlling circuit 40. The controlling circuit 40 starts the buzzer 50 according to the second signal.

In step S5, the magnifying circuit 30 outputs the second signal to the video monitoring system to warn that there may be an intruder too close to the camera 10.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A protecting system for protecting a camera, the protecting system comprising:
an infrared sensor to sense heat, wherein the infrared sensor outputs a first signal upon the condition that the infrared sensor detects heat which reaches a predetermined value;
a magnifying circuit to magnify the first signal and output a second signal;
an annunciator; and
a controlling circuit to receive the second signal to start the annunciator.

2. The protecting system of claim 1, wherein the controlling circuit comprises a switch connected between the annunciator and a power supply.

3. The protecting system of claim 1, wherein the magnifying circuit comprises an amplifier.

4. The protecting system of claim 1, wherein the infrared sensor is mounted on a surface of the camera.

5. The protecting system of claim 1, wherein the annunciator is mounted on a surface of the camera.

6. The protecting system of claim 1, wherein the magnifying circuit is located inside the camera.

7. The protecting system of claim 1, wherein the controlling circuit is located inside the camera.

8. A protecting method for protecting a camera, comprising:
detecting heat by an infrared sensor;
determining whether the infrared sensor detects heat which reaches a predetermined value;
outputting a first signal from the infrared sensor upon the condition that the infrared sensor detects heat which reaches a predetermined value;
magnifying the first signal to obtain a second signal by a magnifying circuit; and
starting an annunciator by a controlling circuit upon the condition that the controlling circuit receives the second signal.

9. The protecting method of claim 8, wherein upon the condition that the infrared sensor does not detect heat which reaches a predetermined value, the infrared sensor continues to detect heat.

10. The protecting method of claim 8, wherein the controlling circuit comprises a switch connected to the buzzer and a power supply.

11. The protecting method of claim 8, wherein the magnifying circuit comprises an amplifier.

12. The protecting method of claim 8, wherein the infrared sensor is mounted on a surface of the camera.

13. The protecting method of claim 8, wherein the annunciator is mounted on a surface of the camera.

14. The protecting method of claim 8, wherein the magnifying circuit is located inside the camera.

15. The protecting method of claim 8, wherein the controlling circuit is located inside the camera.
